(19) United States
(12) Patent Application Publication
(10) Pub. No.: US 2024/0286381 A1
(43) Pub. Date: Aug. 29, 2024

(54) A SELF-ADHERING INSULATION OR COVER BOARD

(71) Applicant: SIKA TECHNOLOGY AG, Baar (CH)

(72) Inventors: Wilfried CARL, Kreuzlingen (CH); Carl DE LEON, Brookline, MA (US); Al DUHAMEL, Tiverton, RI (US); Daniel MUNT, Jersey City, NJ (US)

(73) Assignee: SIKA TECHNOLOGY AG, Baar (CH)

(21) Appl. No.: 18/564,944

(22) PCT Filed: May 25, 2022
(86) PCT No.: PCT/EP2022/064256

§ 371 Date: Nov. 28, 2023

(30) Foreign Application Priority Data
May 31, 2021 (EP) 21176891.6

(51) Int. Cl. B32B 7/06; B32B 5/18; B32B 7/12; B32B 19/04; B32B 21/02; B32B 21/08; B32B 27/06; B32B 27/32; B32B 29/00; B32B 37/26; C09J 5/00; C09J 7/38; C09J 133/08; E04D 11/02

(52) U.S. Cl. CPC B32B 7/06; B32B 5/18; B32B 7/12; B32B 19/045; B32B 21/02; B32B 21/08; B32B 27/065; B32B 27/32; B32B 29/007; B32B 37/26; C09J 5/00; C09J 7/385; C09J 133/08; E04D 11/02; B32B 2037/268; B32B 2255/08; B32B 2255/12; B32B 2255/26; B32B 2307/304; B32B 2307/748; B32B 2405/00; B32B 2419/06; C09J 2301/302; C09J 2433/00

(57) ABSTRACT

An insulation or cover board including a substrate layer, an adhesive layer, and a release liner, wherein the adhesive layer is a dried layer of a water- or solvent-based acrylic pressure sensitive adhesive composition. Also, a method for producing the insulation or cover board and a method for providing a roof system.

### TECHNICAL FIELD

The invention relates to the field of roof systems comprising insulation and/or cover boards. In particular, the invention relates to self-adhering insulation and cover boards having a pressure sensitive adhesive coated one or both sides of the board.

### BACKGROUND OF THE INVENTION

Outer exterior surfaces of buildings must be protected from environmental forces such as wind and rain. Roofing membranes composed of polymeric materials are used for waterproofing of flat or slightly sloped roofs whereas sloped roofs are typically covered with roof shingles. Low-slope roof assemblies are typically composed of a roofing membrane, a rigid insulation and/or cover board, and a roof deck. The roofing membrane is typically applied directly on the top of the insulation board, which is used to improve the thermal insulation properties of the roof assembly. Alternatively, the roofing membrane can be secured to a cover board, which is applied on top of the insulation board. In ventilated and cold roof designs, the insulation board can also be located below the roof deck.

Commonly used materials for the roofing membranes include plastics, in particular thermoplastics such as plasticized polyvinylchloride (p-PVC), thermoplastic olefins (TPE-O, TPO), and elastomers such as ethylene-propylene diene monomer (EPDM). The roofing membranes are typically delivered to a construction site in form of rolls, transferred to the place of installation, unrolled, and adhered to the substrate to be waterproofed. Roofing membranes must be securely fastened to the roof substrate to provide sufficient mechanical strength to resist the shearing forces applied on it due to high wind loads. Roof systems are typically divided into two categories depending on the means used for fastening the roofing membrane to the roof substrate. In a mechanically attached roof system, the roofing membrane is fastened to the roof substrate by using screws and/or barbed plates. Mechanical fastening enables high strength bonding, but it provides direct attachment to the roof substrate only at locations where a mechanical fastener affixes the membrane to the surface, which makes mechanically attached membranes susceptible to flutter. In fully-adhered roof systems the membrane is typically adhered to the roof substrate indirectly by using an adhesive composition.

Insulation boards are typically adhered to the roof deck by using mechanical or adhesive bonding means. In the first case, the fastening used for securing the roofing membrane to the insulation board may also be used for securing the insulation board to the roof deck. In practice the whole roof assembly including the roofing membrane, insulation board and cover board, if used, is attached to the roof deck by using screws that penetrate through the assembly into the roof deck. Alternatively, the insulation board can be secured to the roof deck by using adhesives, typically by contact bonding or by using 2-component polyurethane adhesives. In contact bonding the insulation board and the surface of the roof deck are first coated with a water- or solvent-based contact adhesive. The volatile components of the adhesive are “flashed off” to provide partially dried adhesive films, which are then contacted with each other to effect adhesive bonding between the insulation board and the surface of the roof deck. The main disadvantage of solvent-based adhesives relates to the environmental concerns. All stages of the manufacturing and application process for solvent-based adhesives release volatile organic compounds (VOCs) into the atmosphere. Water-based adhesives may be preferred in terms of environmental aspects, but their use is practically restricted to temperatures of 5° C. and above. Generally, the contact bonding also complicates the installation process since drying of the wet adhesive layers requires considerable amount of time. On the other hand, 2-component polyurethane adhesives are typically used in bead application, and require specialized application equipment, safety measures regarding EHS, and careful control of the curing time, which is especially demanding during hot or cold days. Consequently, majority of the roofs systems are either mechanically fastened or ballasted roofs.

There thus remains a need for a novel type of insulation or cover board, which enables easier installation of roof systems with reduced costs.

### SUMMARY OF THE INVENTION

The object of the present invention is to provide a self-adhering insulation or cover board, which enables easier installation of adhered roof systems.

Another object of the present invention is to provide a self-adhering insulation or cover board, which can be manufactured with decreased production costs.

The subject of the present invention is insulation or cover board as defined in claim 1.

It was surprisingly found out that solvent- or water-based acrylic pressure sensitive adhesives can be used for providing self-adhering insulation and cover boards with reduced production costs.

One of the advantages of the insulation or roofing board of the present invention is that it can be produced using common coating techniques without separate treatment steps, for example, to improve the thermal or chemical stability of the adhesive composition, such as curing by UV-radiation. On the other hand, the pre-applied adhesive layer enables providing self-adhering insulation and cover boards, which enables providing roof systems using a simplified installation process.

Other aspects of the present invention are presented in other independent claims. Preferred aspects of the invention are presented in the dependent claims.

### BRIEF DESCRIPTION OF THE DRAWINGS

FIG. 1 shows a cross-section of an insulation or cover board (1, 1′) comprising a substrate layer (2), an adhesive layer (3) covering the lower primary exterior surface of the substrate layer (2), and a release liner (4) covering the outer major surface of the adhesive layer (3).

FIG. 2 shows a cross-section of an insulation or cover board (1, 1′) comprising a substrate layer (2), a first adhesive layer (3′) covering the lower primary exterior surface of the substrate layer (2), a first release liner (4) covering the outer major surface of the first adhesive layer (3′), a second adhesive layer (3″) covering the upper primary exterior surface of the substrate layer (2), and a second release liner (4′) covering the outer major surface of the second adhesive layer (3″).

FIG. 3 shows a cross-section of a roof system (5) comprising a roof deck (6), an insulation board (1), and a roofing membrane (7) covering the upper major surface of the insulation board (1), wherein the roofing membrane (7) is bonded to the upper major surface of the insulation board (1) via a second adhesive layer (3″) and the insulation board (1) is bonded to a surface of the roof deck (6) via a first adhesive layer (3′).

### DETAILED DESCRIPTION OF THE INVENTION

The subject of the present invention is an insulation or cover board (1, 1′) comprising:
i. a substrate layer (2) having upper and lower primary exterior surfaces,
ii. an adhesive layer (3) covering at least a portion of one of the primary exterior surfaces of the substrate layer (2), and
iii. a release liner (4),
wherein the adhesive layer (3) is a dried layer of a water- or solvent-based acrylic pressure sensitive adhesive composition.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight may be determined by gel permeation chromatography (GPC) using polystyrene as standard, preferably using styrene-divinylbenzene gel with porosity of 100 Angstrom, 1000 Angstrom and 10000 Angstrom as columns and, depending on the molecule, tetrahydrofurane as a solvent, at 35° C., or 1,2,4-trichlorobenzene as a solvent, at 160° C.

The term “melting temperature” refers to a temperature at which a material undergoes transition from the solid to the liquid state. The melting temperature (Tₘ) is preferably determined by differential scanning calorimetry (DSC) according to ISO 11357-3 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one acrylic polymer AP” refers to the sum of the individual amounts of all acrylic polymers AP contained in the composition. Furthermore, in case the composition comprises 20 wt.-% of at least one acrylic polymer AP, the sum of the amounts of all acrylic polymers AP contained in the composition equals 20 wt.-%.

The term “room temperature” designates a temperature of 23° C.

The insulation or cover board of the present invention comprises a substrate layer and an adhesive layer covering at least a portion of one of the primary exterior surfaces of the substrate layer.

The insulation or cover board is preferably a self-adhering insulation or cover board. The term “self-adhering” is understood to mean that the insulation or cover board comprising the adhesive layer is provided as a pre-formed article that has been formed before being installed to a surface of a substrate, such as a roof deck. Such pre-formed articles are fabricated at a location that is typically remote from the construction site, transported to the place of installation, and placed on a surface of a substrate to form a part of a roof system.

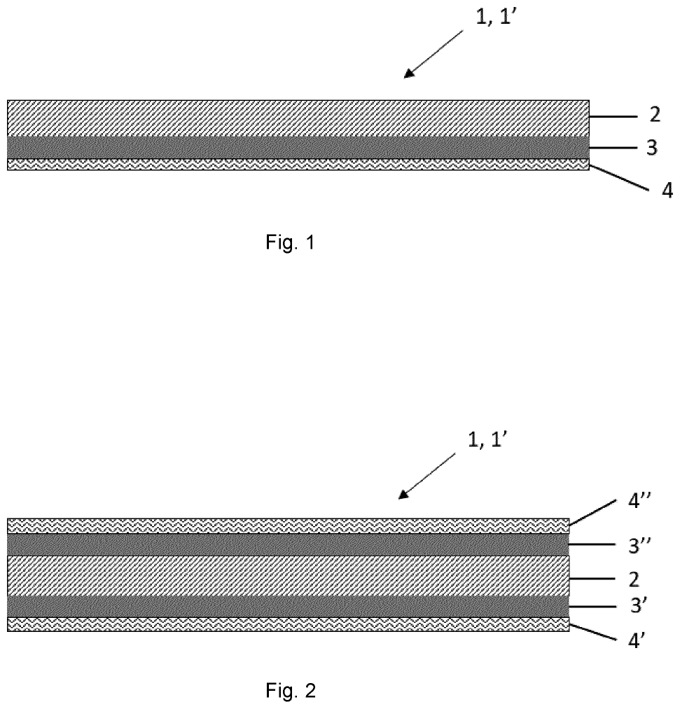

According to one or more embodiments, the adhesive layer covers at least a portion of the lower primary exterior surface, as shown in FIG. 1.

The substrate layer is preferably a sheet-like element having upper and lower primary exterior surfaces, i.e. top and bottom surfaces, defining a thickness of the layer therebetween. Preferably, the substrate layer has a length and width of at least 15 times, more preferably at least 25 times, even more preferably at least 50 times, greater than the thickness of the substrate layer.

Preferably, the adhesive layer covers at least 50%, more preferably at least 65%, most preferably at least 75%, of the area of one of the primary exterior surfaces of the substrate layer. According to one or more embodiments, the adhesive layer covers at least 90%, preferably at least 95%, more preferably at least 97.5%, of the area of one of the primary exterior surfaces of the substrate layer. Furthermore, it can be preferable, for example, to enable easier installation, that narrow segments on one of the primary exterior surfaces of the substrate layer near the longitudinal edges, having a width for example of 1-5 mm, are left free of the adhesive layer.

The adhesive layer is composed of a dried layer of a water- or solvent-based pressure sensitive adhesive.

The term “pressure sensitive adhesive” refers in the present disclosure to viscoelastic materials, which adhere immediately to almost any kind of substrates by application of light pressure and which are permanently tacky. The tackiness of an adhesive layer can be measured, for example, as a loop tack. Preferably, the adhesive layer has a loop tack adhesion to a glass plate measured at a temperature of 23° C. of at least 2.5 N/25 mm, preferably at least 5 N/25 mm, more preferably at least 10 N/25 mm. The loop tack adhesion can be measured using a “FINAT test method no. 9 (FTM 9) as defined in FINAT Technical Handbook, 9th edition, published in 2014.

The term “acrylic pressure sensitive adhesive” designates in the present disclosure pressure sensitive adhesive compositions containing one or more acrylic polymers as the main polymer component.

The term “water-based acrylic adhesive” designates in the present disclosure adhesive compositions comprising one or more acrylic polymers, which have been formulated as an aqueous dispersion, an aqueous emulsion, or as an aqueous colloidal suspension. The term “aqueous dispersion” or “aqueous emulsion” refers to dispersions or emulsions containing water as the main continuous (carrier) phase. Typically, a water-based acrylic pressure sensitive adhesive comprises surfactants to stabilize the hydrophobic polymer particles and to prevent these from coagulating with each other.

The term “solvent-based acrylic pressure sensitive adhesive” designates in the present disclosure adhesive compositions comprising at least one organic solvent and one or more acrylic polymers, which are substantially completely dissolved in the organic solvent(s). Typically, the organic solvent(s) comprise at least 20 wt.-%, preferably at least 30 wt.-%, more preferably at least 40 wt.-%, of the total weight of the adhesive composition. The term “organic solvent” refers in the present document to organic substances that are liquid at a temperature of 25° C., are able to at least partially dissolve another substance, and have a standard boiling point of not more than 225° C., preferably not more than 200° C. The term “standard boiling point” refers in the present disclosure to boiling point measured at a pressure of 1 bar. The standard boiling point of a substance or composition can be determined, for example, by using an ebulliometer.

Suitable organic solvents for the solvent-based acrylic pressure sensitive adhesives include, for example, alcohols, aliphatic and aromatic hydrocarbons, ketones, esters, and mixtures thereof. It is possible to use only a single organic solvent or a mixture of two or more organic solvents. Suitable solvent-based acrylic pressure sensitive adhesives are substantially water-free, for example, containing less than 10 wt.-%, preferably less than 5 wt.-%, more preferably less than 1 wt.-% of water, based on the total weight of the adhesive composition.

The expression “dried adhesive layer” is understood to mean that the adhesive layer has been obtained by applying a water- or solvent-based acrylic pressure sensitive adhesive composition as a wet film and allowing the volatile components to evaporate. Preferably, the adhesive layer comprises not more than 10 wt.-%, preferably not more than 7.5 wt.-%, more preferably not more than 5 wt.-%, even more preferably not more than 2.5 wt.-%, based on the total weight of the adhesive layer, or residual water and/or organic solvents.

According to one or more embodiments, the adhesive layer has a thickness of 50-350 μm, preferably 65-300 μm, more preferably 75-250 μm, even more preferably 80-200 μm.

According to one or more embodiments, adhesive layer comprises at least 50 wt.-%, preferably at least 65 wt.-%, more preferably at least 75 wt.-%, even more preferably at least 85 wt.-%, of at least one acrylic polymer AP, based on the total weight of the adhesive layer.

The term “acrylic polymer” designates in the present disclosure homopolymers, copolymers and higher inter-polymers of an acrylic monomer with one or more further acrylic monomers and/or with one or more other ethylenically unsaturated monomers. The term “acrylic monomer” refers in the present disclosure to monomers having at least one (meth)acryloyl group in the molecule. The term “(meth)acryloyl” designates methacryloyl or acryloyl. Accordingly, the term “(meth)acrylic” designates methacrylic or acrylic. A (meth)acryloyl group is also known as (meth)acryl group. Examples of suitable acrylic monomers for the at least one acrylic polymer AP include, for example, (meth)acrylates, (meth)acrylic acid or derivatives thereof, for example, amides of (meth)acrylic acid or nitriles of (meth)acrylic acid, and (meth)acrylates with functional groups such as hydroxyl group-containing (meth)acrylates and alkyl (meth)acrylates.

The adhesive layer may be present on the surface of the substrate layer in form of a continuous or a discontinuous adhesive layer. The term “continuous adhesive layer” refers in the present disclosure to layers consisting of one single area coated with the adhesive whereas the term “discontinuous adhesive layer” refers to layers consisting of two or more areas coated with the adhesive, which areas are not connected to each other to form a continuous layer. According to one or more embodiments, the adhesive layer is a continuous adhesive layer.

According to one or more embodiments, the water- or solvent-based acrylic pressure sensitive adhesive composition comprises:
a) 25-85 wt.-%, preferably 35-75 wt.-%, of the at least one acrylic polymer AP and
b) 5-85 wt.-%, preferably 10-75 wt.-%, of water or at least one organic solvent, all proportions being based on the total weight of the adhesive composition.

According to one or more embodiments, the at least one acrylic polymer AP has
a glass transition temperature (T_{g}) determined by dynamical mechanical analysis (DMA) as the peak of the measured loss modulus (G″) curve using an applied frequency of 1 Hz and a strain level of 0.1% of below 5° C., preferably of below 0° C., more preferably below −10° C., even more preferably below −20° C. and/or
a number average molecular weight (Mₙ) of 50000-1000000 g/mol, preferably 100000-750000 g/mol, more preferably 150000-500000 g/mol.

According to one or more embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of acrylic monomers of the following formula (I):

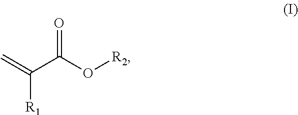

where
R₁ represents a hydrogen or a methyl group; and
R₂ represents a branched, unbranched, cyclic, acyclic, or saturated alkyl group having from 2 to 30 carbon atoms.

Examples of preferred acrylic monomers of formula (I) include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl(meth)acrylate, 2-hydroxypropyl(meth)acrylate, 3-hydroxypropyl (meth)acrylate, 2-hydroxybutyl(meth)acrylate, 4-hydroxybutyl butyl(meth)acrylate, 2-hydroxy-hexyl(meth)acrylate, 6-hydroxy hexyl(meth) acrylate, 8-hydroxyoctyl(meth)acrylate, 10-hydroxydecyl (meth)acrylate, 12-hydroxylauryl(meth)acrylate. Further suitable hydroxyl group containing acrylic monomers include (4-hydroxymethyl cyclohexyl)methyl acrylate, polypropylene glycol mono (meth)acrylate, N-hydroxyethyl (meth)acrylamide, and N-hydroxypropyl (meth)acrylamide.

According to one or more embodiments, the monomer mixture used for obtaining the at least one acrylic polymer AP comprises not more than 25 wt.-%, preferably not more than 20 wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of at least one acrylic polymer AP include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, and vinyl acetate.

According to one or more embodiments, the monomer mixture used for obtaining the at least one acrylic polymer AP comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth)acrylamides, N-substituted (meth)acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth)acrylates.

In addition to the at least one acrylic polymer AP, the water- or solvent-based acrylic pressure sensitive adhesive composition may further comprise one or more additional constituents including, for example, tackifying resins, waxes, and plasticizers as wells as one or more additives, such as UV-light absorption agents, UV- and heat stabilizers, optical brighteners, pigments, dyes, and desiccants. Preferably, the total amount of such additional constituents and additives is not more than 35 wt.-%, more preferably not more than 25 wt.-%, most preferably not more than 15 wt.-%, based on the total weight of the adhesive composition.

According to one or more embodiments, the water- or solvent-based acrylic pressure sensitive adhesive composition comprises:
a) 25-85 wt.-%, preferably 35-75 wt.-%, of the at least one acrylic polymer AP,
b) 5-85 wt.-%, preferably 10-75 wt.-%, of water or at least one organic solvent, and
c) 0.5-35 wt.-%, preferably 2.5-25 wt.-%, of at least one tackifying resin, all proportions being based on the total weight of the adhesive composition.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C.

Examples of suitable tackifying resins to be used in the acrylic pressure sensitive adhesive include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas.

Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

According to one or more embodiments, the at least one tackifying resin has:
a softening point measured by a Ring and Ball method according to DIN EN 1238 standard in the range of 65-185° C., preferably 75-175° C., more preferably 80-170° C. and/or
a number average molecular weight (Mₙ) in the range of 150-5000 g/mol, preferably 250-3500 g/mol, more preferably 250-2500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

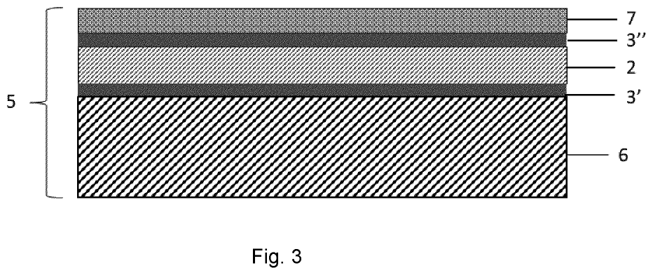

According to one or more embodiments, the insulation or cover board (1, 1′) comprises a first adhesive layer (3′) covering at least a portion of the lower primary exterior surface of the substrate layer (2) and a second adhesive layer (3″) covering at least a portion of the upper primary exterior surface of the substrate layer (2), as shown in FIG. 2. The preferences given above for the adhesive layer (3) apply equally for the first and second adhesive layers (3′, 3″).

The insulation or cover board further comprises a release liner, which is typically used to prevent premature unwanted adhesion and to protect the adhesive layer from moisture, fouling, and other environmental factors. The release liner is preferably arranged to cover the outer major surface of the adhesive layer facing away from the substrate layer. Preferably, the release liner covers at least 75%, more preferably at least 85%, even more preferably at least 95%, still more preferably at least 97.5%, of the outer major surface of the adhesive layer.

The release liner may be sliced into multiple sections to allow portioned detachment of the release liner from the adhesive layer. Furthermore, size of the planar area of the release liner, calculated as width times length of the release liner, may exceed the size of the respective planar area of the of the substrate layer. In these embodiments, the release liner extends beyond the short and/or long edges of the substrate layer to form one or more short/long edge flaps. The width of such edge flap is preferably not more than 5 mm, more preferably 0.5-2.5 mm, even more preferably 1-2 mm.

According to one or more embodiments, the release liner is a polymeric film or a polymer-coated paper.

Suitable polymeric films for the release liner include, for example, polyethylene, polypropylene, and polyester films, optionally coated with polymeric release agents, such as silicone, silicone urea, urethanes, waxes, and long chain alkyl acrylate release agents. Suitable polymer-coated papers include at least Kraft paper, polyethylene coated paper, and silicone coated paper.

According to one or more embodiments, the insulation or cover board comprises a first release liner (4′) covering the outer major surface of the first adhesive layer (3′) facing away from the substrate layer (2) and a second release liner (4″) covering the outer major surface of the second adhesive layer (3″) facing away from the substrate layer (2). The preferences given above for the release liner apply equally for the first and second release liners.

According to a first embodiment, the substrate layer comprises a low-density panel, preferably a foam panel having a closed cell structure. The low-density panel is preferably a sheet-like element having upper and lower major surfaces, i.e. top and bottom surfaces, defining a thickness of the panel therebetween. Such low-density panels ere especially suitable for use as insulation boards.

Suitable foam panels having a closed cell structure include, for example, molded expanded polystyrene (EPS) foam panels, extruded expanded polystyrene (XPS) foam panels, polyurethane foam panels (PUR), and polyisocyanurate (PIR) foam panels.

The thickness of the foam panel is not particularly restricted. It may be preferable that the foam panel has a thickness determined by using the measurement method as defined in DIN EN 1849-2 standard of 5-500 mm, preferably 10-350 mm, even more preferably 25-150 mm.

According to one or more embodiments, the foam panel is a molded expanded polystyrene (EPS) foam panel, an extruded expanded polystyrene (XPS) foam panel, a polyurethane foam panel (PUR), or a polyisocyanurate (PIR) foam panel, preferably having a density of 10-150 g/l, more preferably 15-100 g/l, even more preferably 25-75 g/l.

According to one or more embodiments, the substrate layer further comprises a first facer attached to at least a portion of the upper major surface of the foam panel and/or a second facer attached to at least a portion of the lower major surface of the foam panel.

Preferably, the first and/or second facer covers at least 50%, more preferably at least 75%, even more preferably at least 85%, still more preferably at least 95%, of the total area of the upper and/or lower major surface of the foam panel, respectively.

According to one or more embodiments, the outer major surface of the first facer facing away from the foam panel forms the upper primary exterior surface of the substrate layer and/or the outer major surface of the second facer facing away from the foam panel forms the lower primary exterior surface of the substrate layer.

Suitable materials for the first and second facers include, for example, metals, such as aluminum foils, cellulosic fibers, reinforced cellulosic fibers, Kraft paper, coated glass fiber mats, uncoated glass fiber mats, chopped glass, and combinations thereof. Further suitable facer materials include fiber board, perlite board, and gypsum board.

The thickness of the facers is not particularly restricted, and it depends mainly on the material of the facers. It may be preferred that the first and second facers have a thickness of 0.15-10 mm, more preferably 0.25-5 mm, even more preferably 0.35-2.5 mm. In case of more rigid facer material, such as fiber or gypsum board, preferred thickness can be in the range of 0.5-35 mm, more preferably 0.65-25 mm.

According to a second embodiment, the substrate layer comprises a high-density panel. The high-density panel is preferably a sheet-like element having upper and lower major surfaces, i.e. top and bottom surfaces, defining a thickness of the panel therebetween.

The high-density panel is preferably selected from the group consisting of a gypsum, fiber-reinforce gypsum, plywood, compressed wood, wood fiber, cementitious, high-density (compressed) polyisocyanurate, perlite, mineral fiber, or an oriented strand panel. Such high-density panels are especially suitable for use as cover boards. These are durable and provide superior impact and puncture resistance. It may be preferred that the high-density panel has a density of at least 100 g/l, more preferably at least 150 g/l, even more preferably at least 200 g/l, still more preferably at least 250 g/l and/or not more than 1500 g/l, more preferably not more than 1250 g/l, even more preferably not more than 1050 g/l, still more preferably not more than 950 g/l.

The thickness of the high-density panel is not particularly restricted. It may be preferable that the high-density panel has a thickness of 5-250 mm, more preferably 10-200 mm, even more preferably 15-150 mm, still more preferably 30-120 mm.

The preferences given above for the substrate layer, the adhesive layers, and the release liners apply equally to all subjects of the present invention unless otherwise stated.

Another subject of the present invention is a method for producing an insulation or cover board of the present invention, the method comprising steps of:
A) Providing the substrate layer (2),
B) Providing the adhesive layer (3) on one of the primary exterior surfaces of the substrate layer (2), and
C) Covering at least a portion the outer major surface of the adhesive layer (3) facing away from the substrate layer with the release liner (4).

According to one or more embodiments, step B) of the method comprises:
B1) Applying the water- or solvent-based acrylic pressure sensitive adhesive composition as a wet adhesive film onto one of the primary exterior surfaces of the substrate layer and
B2) Drying the wet adhesive film by allowing the volatile components to evaporate, or
B1′) Applying the water- or solvent-based acrylic pressure sensitive adhesive composition as a wet adhesive film onto a surface of transfer sheet,
B2′) At least partially drying the wet adhesive film by allowing at least a portion of the volatile components to evaporate, and
B3′) Transferring the at least partially dried adhesive film to one of the primary exterior surfaces of the substrate layer.

The water- or solvent-based acrylic pressure sensitive adhesive composition may be applied to a surface of the substrate layer by using any conventional techniques, such as slot die coating, extrusion coating, roller coating, direct gravure coating, offset gravure coating, reverse gravure roll-coating, or by using powder dispersion, spray lamination, screen printing or ink jet printing techniques.

According to one or more embodiments, the wet adhesive film has a coating weight of 100-1000 g/m², preferably 150-750 g/m², more preferably 150-500 g/m².

According to one or more embodiments, step B3′) of the method is conducted by laminating the transfer sheet to one of the primary exterior surfaces of the substrate layer such that the at least partially dried adhesive film is positioned between the transfer sheet and the substrate layer. The transfer sheet may be delaminated from the surface of the substrate layer after step B3′) or left to the surface of the substrate layer to perform as the release liner.

Preferably, the wet adhesive film obtained from step B1′) is essentially completely dried in step B2′) to obtain a dried adhesive film, which is then transferred to one of the primary exterior surfaces of the substrate layer in step B3′).

Still another subject of the present invention is a method for providing a roof system (5), the method comprising steps of:
I) Providing an insulation board (1) of the present invention and
II) Positioning the insulation board (1) on a surface of a roof deck (6) and pressing the insulation board (1) against the surface of the roof deck (6) with a pressure sufficient to effect adhesive bonding between the insulation board (1) and the roof deck (6).

The term “roof deck” refers in the present disclosure to a structural supporting surface of a building extending between the surrounding exterior walls of the building. A roof deck may be composed, for example, of plywood, metal or concrete.

Preferably, at least 50%, more preferably at least 75%, even more preferably at least 85%, still more preferably at least 95%, of the entire area of the lower major surface of the insulation board (1) is bonded to the surface of the roof deck (6) via the adhesive layer (3) or with the first adhesive layer (3′).

According to one or more embodiments, the method comprises a further step of:
III) Covering at least a portion of the upper major surface of the insulation board (1) with a roofing membrane (7) or with a cover board (1′) of the present invention and
IV) Pressing the roofing membrane (7) or the cover board (1′) against the surface of the insulation board (1) with a pressure sufficient to effect adhesive bonding between the roofing membrane (7) and the insulation board (1) or between the cover board (1′) and the insulation board (1).

According to one or more embodiments, the roofing membrane (7) is a self-adhering roofing membrane comprising at least one waterproofing layer and a layer of a pressure sensitive adhesive. In these embodiments, the insulation board (1) provided in step I) of the method preferably comprises an adhesive layer (3) covering at least a portion of the lower primary exterior surface of the substrate layer (2) and at least a portion of the lower major surface of the insulation board (1) is bonded to the surface of the roof deck (6) via the adhesive layer (3).

Suitable self-adhering roofing membranes are commercially available, for example, from Sika AG under the trade name of Sarnafil® G 410 SA and Sarnafil® TG 76 FSA; from Versico Roofing Systems under the trade name of VersiWeld® QA; and from Carlisle SynTec Systems under the trade name of Sure-Weld® TPO SAT.

According to one or more further embodiments, the roofing membrane (7) is a non-self-adhering roofing membrane comprising at least one waterproofing layer. In these embodiments, the insulation board (1) provided in step I) of the method preferably comprises a first adhesive layer (3′) covering at least a portion of the lower primary exterior surface of the substrate layer (2) and a second adhesive layer (3″) covering at least a portion of the upper primary exterior surface of the substrate layer (2), wherein at least a portion of the lower major surface of the roofing membrane (7) is bonded to the upper major surface of the insulation board (1) via the second adhesive layer (3″) and at least a portion of the lower major surface of the insulation board (1) is bonded to the surface of the roof deck (6) via the first adhesive layer (3′). A roof system (5) obtained by using a method according to these embodiments is shown in FIG. 3.

Commonly used materials for the at least one waterproofing layer of the roofing membrane include plastics, in particular thermoplastics such as plasticized polyvinylchloride (p-PVC), thermoplastic olefins (TPE-O, TPO), elastomers such as ethylene-propylene diene monomer (EPDM), and bitumen. The thickness of the at least one waterproofing layer is not particularly restricted, and it depends mainly on the material of the waterproofing layer as well as on the number of waterproofing layers in the roofing membrane. According to one or more embodiments, the at least one waterproofing layer has a thickness determined by using the measurement method as defined in DIN EN 1849-2 standard of 0.25-5 mm, preferably 0.5-4.5 mm, more preferably 1-3 mm, most preferably 1-2.5 mm.

According to one or more embodiments, at least a portion of the upper major surface of the insulation board (1) is covered with a cover board (1′) in step III) of the method, wherein the cover board (1′) comprises an adhesive layer (3C) covering at least a portion of the lower primary exterior surface of the substrate layer (2C). In these embodiments, the insulation board (1) provided in step I) of the method preferably comprises an adhesive layer (31) covering at least a portion of the lower primary exterior surface of the substrate layer (21), wherein at least a portion of the lower major surface of the cover board (1′) is bonded to the upper major surface of the insulation board (1) via the adhesive layer (3C) of the cover board (1′) and at least a portion of the lower major surface of the insulation board (1) is bonded to the surface of the roof deck (6) via the adhesive layer (31) of the insulation board (1).

### EXAMPLES

### Preparation of a Self-Adhering Cover Boards

Two different types of cover boards were used for preparing the self-adhering cover boards; a plywood board and a DenseDeck® Prime gypsum cover board (from Georgia-Pacific Gypsum LLC).

A sample of the coverboard having a size 10 cm×10 cm was covered with a wet film of a dispersion-based acrylic pressure sensitive adhesive (Acronal® A 240 from BASF) having a thickness of 280 μm. The wet film was dried for 30 minutes at 80° C. by allowing the volatile components to evaporate to obtain a dried adhesive film having a thickness of 140 μm. The dried adhesive film was then covered with a siliconized polyolefin release liner having a thickness of 80 μm.

### Vertical Pull Test

A sample of a paper faced polyisocyanurate (PIR) insulation board Atlas® AC II (from Atlas Roofing Corporation) having a size of 15 cm×22.5 cm, was clamped as base in an Instron tensile tester (model 3300).

The release liner of the tested self-adhering cover board was removed, and the cover board was pressed against the upper surface of the PIR insulation board to effect adhesive bonding between the cover board and the insulation board. Having the cover board clamped to the tensile tester, a vertical pull test using a pulling speed of 1.25 cm/min was performed.

A vertical pull resistance of 0.02 N/mm² (418 psf) and 0.04 N/mm² (835 psf) were obtained with the plywood and gypsum cover boards, respectively. The measured values of the pull resistance clearly exceed the minimum requirement of 60 psf according to FM 4450, Approval Standard for Class 1 Insulated Steel Roof Decks.

1. An insulation or cover board comprising:
i. a substrate layer having upper and lower primary exterior surfaces,
ii. an adhesive layer covering at least a portion of one of the primary exterior surfaces of the substrate layer, and
iii. a release liner,
wherein the adhesive layer is a dried layer of a water- or solvent-based acrylic pressure sensitive adhesive composition.

2. The board according to claim 1, wherein the adhesive layer comprises not more than 10 wt.-%, based on the total weight of the adhesive layer, of residual water and/or organic solvents.

3. The board according to claim 1, wherein the adhesive layer has a thickness of 50-350 μm.

4. The board according to claim 1, wherein adhesive layer comprises at least 50 wt.-% of at least one acrylic polymer AP, based on the total weight of the adhesive layer.

5. The board to claim 4, wherein the at least one acrylic polymer AP has a glass transition temperature (T_{g}) determined by dynamical mechanical analysis (DMA) using an applied frequency of 1 Hz and a strain level of 0.1% of below 0° C. and/or a number average molecular weight (Mₙ) determined by gel permeation-chromatography using polystyrene as standard of 50000-1000000 g/mol.

6. The board according to claim 1, wherein the release liner is a polymeric film or a polymer-coated paper.

7. The board according to claim 1, wherein the substrate layer comprises a low-density panel.

8. The board according to claim 7, wherein the foam panel is a molded expanded polystyrene (EPS) foam panel, an extruded expanded polystyrene (XPS) foam panel, a polyurethane foam panel (PUR), or a polyisocyanurate (PIR) foam panel.

9. The board according to claim 7, wherein the substrate layer further comprises a first facer attached to at least a portion of the upper major surface of the foam panel and/or a second facer attached to at least a portion of the lower major surface of the foam panel.

10. The board according to claim 1, wherein the substrate layer comprises a high-density panel selected from the group consisting of a gypsum, fiber-reinforce gypsum, plywood, compressed wood, wood fiber, cementitious, high-density (compressed) polyisocyanurate, perlite, mineral fiber, or an oriented strand panel.

11. A method for producing an insulation or cover board according to claim 1, the method comprising steps of:
A) providing the substrate layer,
B) providing the adhesive layer on one of the primary exterior surfaces of the substrate layer, and
C) covering at least a portion of the outer major surface of the adhesive layer facing away from the substrate layer with a release liner.

12. The method according to claim 11, wherein step B) comprises:
B1) applying the water- or solvent-based acrylic pressure sensitive adhesive composition as a wet adhesive film onto one of the primary exterior surfaces of the substrate layer and
B2) drying the wet adhesive film by allowing the volatile components to evaporate,
or
B1′) applying the water- or solvent-based acrylic pressure sensitive adhesive composition as a wet adhesive film onto a surface of a transfer sheet,
B2′) at least partially drying the wet adhesive film by allowing at least a portion of the volatile components to evaporate, and
B3′) transferring the at least partially dried adhesive film to one of the primary exterior surfaces of the substrate layer.

13. The method according to claim 12, wherein the wet adhesive film has a coating weight of 100-1000 g/m².

14. A method for providing a roof system comprising steps of:
I) providing an insulation board according to claim 1 and
II) positioning the insulation board on a surface of a roof deck and pressing the insulation board against the surface of the roof deck with a pressure sufficient to effect adhesive bonding between the insulation board and the roof deck.

15. The method according to claim 14 comprising a further step of:
III) covering at least a portion of the upper major surface of the insulation board with a roofing membrane or with a cover board according to claim 1 and
IV) pressing the roofing membrane or the cover board against the surface of the insulation board with a pressure sufficient to effect adhesive bonding between the roofing membrane and the insulation board or between cover board and the insulation beard board.
